(19) United States
(12) Patent Application Publication
(10) Pub. No.: US 2026/0155930 A1
(43) Pub. Date: Jun. 4, 2026

(54) POSITIONING

(71) Applicant: Nokia Technologies Oy, Espoo (FI)

(72) Inventors: Ryan KEATING, Naperville, NJ (US); Hyun-Su CHA, Naperville, NJ (US); Tao TAO, Shanghai (CN)

(21) Appl. No.: 18/998,322

(22) PCT Filed: Sep. 28, 2022
(86) PCT No.: PCT/CN2022/122309

§ 371 Date: Jan. 24, 2025

(51) Int. Cl. H04L 5/00

(52) U.S. Cl. CPC H04L 5/005; H04L 5/0012; H04W 64/00

(57) ABSTRACT

Embodiments of the present disclosure relate to for positioning. A first device receives configuration information associated with a first RS for positioning the first device, from a second device in the radio access network. The configuration information comprises frequency hopping configuration associated with transmission of the first RS. The first device receives a second RS for positioning the first device from the second device on a first frequency hop and a second frequency RS hop overlapping with the first frequency hop in frequency domain. The first device causes pre-compensation for the transmission of the first RS to be performed based on a phase offset obtained from the received second RS. The first device transmits the first RS to the second device based on the configuration information.

### FIELD

Embodiments of the present disclosure generally relate to the field of telecommunication and in particular, to devices, methods, apparatus and computer readable storage media for Multi-cell Round Trip Time (Multi-RTT) positioning.

### BACKGROUND

A New radio (NR) system provides positioning support. The following positioning solutions were specified for NR Release 16: Downlink Time Difference of Arrival (DL-TDOA), Uplink Time Difference of Arrival (UL-TDOA), Downlink Angle of Departure (DL-AoD), Uplink Angle of Arrival (UL-AoA) and Multi-cell Round Trip Time (Multi-RTT).

In Release 17, the Third Generation Partnership Project (3GPP) started NR positioning enhancement work which focuses on increasing accuracy, reducing latency and increasing efficiency based on Release 16 solutions.

Reduced Capability (RedCap) devices are being designed and standardized in Release 17. The RedCap devices are designed with relatively longer battery life compared to Internet of Things (IoT) devices. It is expected that positioning of RedCap devices will be included in a Release 18 work item (WI) as it is currently a study objective in the Release 18 study item (SI).

### SUMMARY

In general, example embodiments of the present disclosure provide a solution for positioning.

In a first aspect, there is provided a first device. The first device comprises at least one processor and at least one memory storing instructions. When the instructions are executed by the at least one processor, the instructions cause the first device at least to: receive configuration information associated with a first reference signal (RS) for positioning the first device, from a second device in the radio access network, the configuration information comprising frequency hopping configuration associated with transmission of the first RS; receive a second RS for positioning the first device from the second device on a first frequency hop and a second frequency hop overlapping with the first frequency hop in frequency domain; cause pre-compensation for the transmission of the first RS to be performed based on a phase offset obtained from the received second RS; and transmit the first RS to the second device based on the configuration information.

In a second aspect, there is provided a second device. The second device comprises at least one processor and at least one memory storing instructions. When the instructions are executed by the at least one processor, the instructions cause the second device at least to: transmit configuration information associated with a first RS to a first device in the radio access network, the configuration information comprising frequency hopping configuration associated with transmission of the first RS from the first device; and receive the first RS from the first device based on the configuration information.

In a third aspect, there is provided a third device. The third device comprises at least one processor and at least one memory storing instructions. When the instructions are executed by the at least one processor, the instructions cause the third device at least to: transmit, to at least one of a first device and a second device in a radio access network, an indication indicating pre-compensation is to be performed, the pre-compensation being for transmission of an RS for positioning of the first device.

In a fourth aspect, there is provided a first device. The first device comprises at least one processor and at least one memory storing instructions. When the instructions are executed by the at least one processor, the instructions cause the first device at least to: receive configuration information associated with a second RS for positioning the first device, from a second device in the radio access network, the configuration information comprising frequency hopping configuration associated with transmission of the second RS from the second device; and receive the second RS from the second device based on the configuration information.

In a fifth aspect, there is provided a second device. The second device comprises at least one processor and at least one memory storing instructions. When the instructions are executed by the at least one processor, the instructions cause the second device at least to: transmit, to a first device in the radio access network, configuration information associated with a second RS for positioning the first device, the configuration information comprising frequency hopping configuration associated with transmission of the second RS; receive, from the first device, a first RS for positioning the first device on a third frequency hop and a fourth frequency hop overlapping with the third frequency hop in frequency domain; perform pre-compensation for transmission of the second RS based on a phase offset obtained from the received first RS; and transmit the second RS to the first device based on the configuration information.

In a sixth aspect, there is provided a method. The method may be performed by a first device in a radio access network and comprises: receiving configuration information associated with a first RS for positioning the first device, from a second device in the radio access network, the configuration information comprising frequency hopping configuration associated with transmission of the first RS; receiving a second RS for positioning the first device from the second device on a first frequency hop and a second frequency hop overlapping with the first frequency hop in frequency domain; causing pre-compensation for the transmission of the first RS to be performed based on a phase offset obtained from the received second RS; and transmitting the first RS to the second device based on the configuration information.

In a seventh aspect, there is provided a method. The method may be performed by a second device in a radio access network and comprises: transmitting configuration information associated with a first RS to a first device in the radio access network, the configuration information comprising frequency hopping configuration associated with transmission of the first RS from the first device; and receiving the first RS from the first device based on the configuration information.

In an eighth aspect, there is provided a method. The method may be performed by a third device and comprises: transmitting, to at least one of a first device and a second device in a radio access network, an indication indicating pre-compensation is to be performed, the pre-compensation being for transmission of an RS for positioning of the first device.

In a ninth aspect, there is provided a method. The method may be performed by a first device in a radio access network and comprises: receiving configuration information associated with a second RS for positioning the first device, from a second device in the radio access network, the configuration information comprising frequency hopping configuration associated with transmission of the second RS from the second device; and receiving the second RS from the second device based on the configuration information.

In a tenth aspect, there is provided a method. The method may be performed by a second device in a radio access network and comprises: transmitting, to a first device in the radio access network, configuration information associated with a second RS for positioning the first device, the configuration information comprising frequency hopping configuration associated with transmission of the second RS; receiving, from the first device, a first RS for positioning the first device on a third frequency hop and a fourth frequency hop overlapping with the third frequency hop in frequency domain; performing pre-compensation for transmission of the second RS based on a phase offset obtained from the received first RS; and transmitting the second RS to the first device based on the configuration information.

In an eleventh aspect, there is provided a first apparatus. The first apparatus comprises: means for receiving configuration information associated with a first RS for positioning a first device in a radio access network, from a second device in the radio access network, the configuration information comprising frequency hopping configuration associated with transmission of the first RS; means for receiving a second RS for positioning the first device from the second device on a first frequency hop and a second frequency hop overlapping with the first frequency hop in frequency domain; means for causing pre-compensation for the transmission of the first RS to be performed based on a phase offset obtained from the means for received second RS; and means for transmitting the first RS to the second device based on the configuration information.

In a twelfth aspect, there is provided a second apparatus. The second apparatus comprises: means for transmitting configuration information associated with a first RS to a first device in a radio access network, the configuration information comprising frequency hopping configuration associated with transmission of the first RS from the first device; and means for receiving the first RS from the first device based on the configuration information.

In a thirteenth aspect, there is provided a third apparatus. The third apparatus comprises means for transmitting, to at least one of a first device and a second device in a radio access network, an indication indicating pre-compensation is to be performed, the pre-compensation being for transmission of an RS for positioning of the first device.

In a fourteenth aspect, there is provided a first apparatus. The first apparatus comprises: means for receiving configuration information associated with a second RS for positioning a first device in a radio access network, from a second device in the radio access network, the configuration information comprising frequency hopping configuration associated with transmission of the second RS from the second device; and means for receiving the second RS from the second device based on the configuration information.

In a fifteenth aspect, there is provided a second apparatus. The second apparatus comprises: means for transmitting, to a first device in the radio access network, configuration information associated with a second RS for positioning the first device, the configuration information comprising frequency hopping configuration associated with transmission of the second RS; means for receiving, from the first device, a first RS for positioning the first device on a third frequency hop and a fourth frequency hop overlapping with the third frequency hop in frequency domain; means for performing pre-compensation for transmission of the second RS based on a phase offset obtained from the received first RS; and means for transmitting the second RS to the first device based on the configuration information.

In a sixteenth aspect, there is provided a computer readable medium. The computer readable medium comprises program instructions that, when executed by at least one processor, cause an apparatus to perform at least the method according to any of the sixth to tenth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example of multi-RTT positioning in accordance with some example embodiments of the present disclosure;

FIG. 3 illustrates an example of frequency hopping for a reference signal in accordance with some example embodiments of the present disclosure;

FIG. 4 illustrates a signaling chart illustrating a process for positioning in accordance with some example embodiments of the present disclosure;

FIGS. 5A and 5B illustrate an example of frequency hops for transmission of a reference signal in accordance with some example embodiments of the present disclosure, respectively;

FIG. 6 illustrates a signaling chart illustrating a process for positioning in accordance with some other example embodiments of the present disclosure;

FIG. 7 illustrates a signaling chart illustrating a process for positioning in accordance with still other example embodiments of the present disclosure;

FIGS. 8A and 8B illustrate an example of frequency hops for transmission of a reference signal in accordance with some example embodiments of the present disclosure, respectively;

FIG. 9 illustrates a flowchart of a method implemented at a first device in accordance with some example embodiments of the present disclosure;

FIG. 10 illustrates a flowchart of a method implemented at a second device in accordance with other example embodiments of the present disclosure;

FIG. 11 illustrates a flowchart of a method implemented at a third device in accordance with other example embodiments of the present disclosure;

FIG. 12 illustrates a flowchart of a method implemented at a first device in accordance with some example embodiments of the present disclosure;

FIG. 13 illustrates a flowchart of a method implemented at a second device in accordance with other example embodiments of the present disclosure;

FIG. 14 illustrates a simplified block diagram of an apparatus that is suitable for implementing embodiments of the present disclosure; and FIG. 15 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

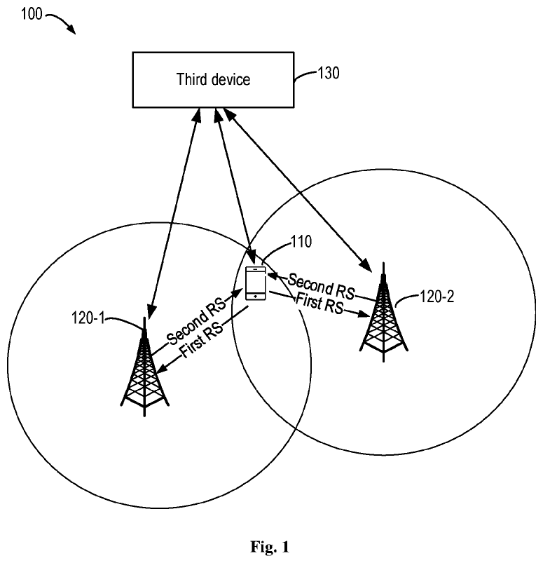

FIG. 1 shows an example communication network 100 in which embodiments of the present disclosure can be implemented. The network 100 may comprise a first device 110, second devices 120-1 and 120-2, and a third device 130 that can communicate with each other. Hereinafter, for brevity, the second devices 120-1 and 120-2 may be collectively referred to as second devices 120 or individually referred to as a second device 120.

In some embodiments, some of the first device 110, the second devices 120 and the third device 130 may be implemented as terminal devices, and others may be implemented as network devices. In such embodiments, for example, the first device 110 may be implemented as a terminal device in a radio access network. For example, the first device 110 may be implemented as a Reduced Capability (RedCap) device. In such embodiments, the second device 120 may be implemented as a network device in the radio access network, and the third device 130 may be implemented as a network device in the radio access network or in a core network. For example, the second device 120 may be implemented as a gNB and the third device 130 may be implemented as a Location Management Function (LMF) entity. The LMF entity may be implemented in the radio access network or in the core network.

In such embodiments, the second device 120-1 may be serving the first device 110, and the second device 120-2 may be not serving the first device 110. In such embodiments, the second device 120-1 may be referred to as a serving network device and the second device 120-2 may be referred to as a neighbor network device.

In addition, in such embodiments, each of the second devices 120-1 and 120-2 may be implemented as a transmission reception point (TRP).

In other embodiments, each of the first device 110, the second devices 120 and the third device 130 may be implemented as a terminal device. In such embodiments, the first device 110, the second devices 120 and the third device 130 may communicate with each other via a sidelink therebetween.

It is to be understood that the number of network devices and terminal devices is only for the purpose of illustration without suggesting any limitations. The network 100 may include any suitable number of network devices and terminal devices adapted for implementing embodiments of the present disclosure. Although not shown, it would be appreciated that one or more terminal devices may be served by the second device 120. In addition, it would be appreciated that there may be more neighbor network devices near the terminal device.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some embodiments, multi-RTT positioning of the first device 110 may be performed in the network 100.

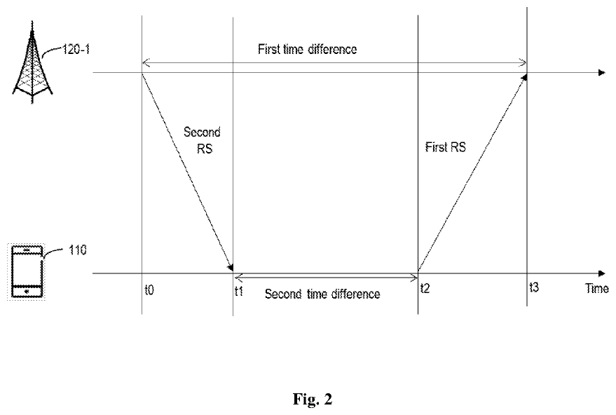

FIG. 2 illustrates an example of multi-RTT positioning in accordance with some example embodiments of the present disclosure. As shown in FIG. 2, for the purpose of multi-RTT positioning, the second device 120-1 transmits a second reference signal (RS) to the first device 110 and records the time (represented by t0) of transmitting the second RS. Upon receiving the second RS from the second device 120-1, the first device 110 records the time (represented by t1) of receiving the second RS.

The first device 110 transmits a first RS to the second device 120-1 and records the time (represented by t2) of transmitting the first RS. Upon receiving the first RS from the first device 110, the second device 120-1 records the time (represented by t3) of receiving the first RS. In turn, the second device 120-1 may determine a first time difference between t3 and t0, i.e., t3−t0.

In some embodiments, the first device 110 may determine a second time difference between t2 and t1 (i.e., t2−t1) and transmit the second time difference to the second device 120-1.

Upon receiving the second time difference (t2−t1), the second device 120-1 may determine a first RTT between the second device 120-1 and the first device 110 based on the first time difference and the second time difference. For example, the second device 120-1 may determine the first RTT to be a difference between the first time difference and the second time difference, i.e., (t3−t0)−(t2−t1).

Similarly, the second device 120-2 may determine a second RTT between the second device 120-2 and the first device 110.

In some embodiments, the second device 120-1 and the second device 120-2 may transmit the first RTT and the second RTT to the third device 130, respectively. Alternatively, the first device 110 and the second devices 120 may transmit respective time differences to the third device 130 directly and the third device 130 may determine the respective RTTs. In turn, the third device 130 may determine a position of the first device 110 based on the first RTT and the second RTT.

Alternatively, the second device 120-2 may transmit the second RTT to the second device 120-1. In turn, the second device 120-1 may determine the position of the first device 110 based on the first RTT and the second RTT.

In some embodiments, frequency hopping for at least one of the first RS and the second RS may be applied so as to increase the effective bandwidth for positioning while keeping the instantaneous bandwidth within a maximum bandwidth, such as the RedCap maximum bandwidth. For example, the RedCap maximum bandwidth may be 20 MHz for FR1 and 100 MHz for FR2.

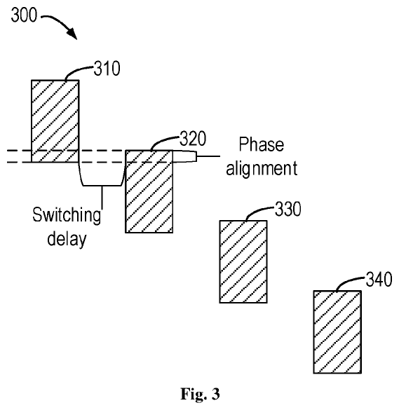

FIG. 3 illustrates an example of frequency hopping 300 for the second RS in accordance with some example embodiments of the present disclosure. As shown in FIG. 3, the first device 110 receives the second RS on frequency hops 310, 320, 330 and 340. In order to receive the second RS on different frequency hops, the first device 110 may need to perform Bandwidth Part (BWP) switching. Thus, switching delay may be caused.

In embodiments where frequency hopping for the second RS is applied, the first device 110 may need to have some resource elements (REs), resource blocks (RBs) or subcarriers overlapped between frequency hops in order to perform a phase alignment between the frequency hops. For example, FIG. 3 illustrates some REs, RBs or subcarriers overlapped between the frequency hops 310 and 320.

If the phase alignment is not performed, the first device 110 may be unable to successfully combine different parts of the second RS on the frequency hops 310, 320, 330 and 340 to take advantage of the total bandwidth aggregated by the multiple frequency hops.

The phase alignment may be performed at the first device 110 or at the second device 120. The phase alignment needs to spend more resources as the overlap needs to occur and also increases the complexity of the measurement procedure.

In order to solve the above and other potential problems, in a first aspect, embodiments of the present disclosure provide a solution for positioning. In the solution, a first device receives a second RS for positioning the first device from a second device on a first frequency hop and a second frequency hop overlapping with the first frequency hop in frequency domain. The first device obtains a phase offset from the received second RS. In turn, the first device performs pre-compensation for the transmission of the first RS to be performed based on the phase offset obtained from the received second RS. In this way, the need for phase alignment at the receiver of the first RS may be eliminated.

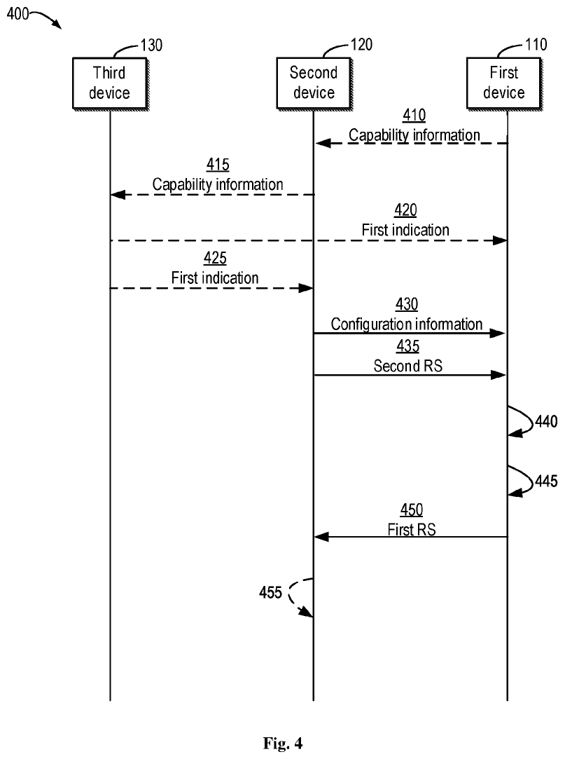

Hereinafter, some embodiments of the present disclosure according to the first aspect will be described with reference to FIGS. 4 to 6.

FIG. 4 illustrates a signaling chart illustrating a process 400 for positioning in accordance with some example embodiments of the present disclosure. For the purpose of discussion, the process 400 will be described with reference to FIG. 1. The process 400 may involve the first device 110, the second device 120 and the third device 130 in FIG. 1.

As shown in FIG. 4, the second device 120 transmits 430 configuration information associated with a first RS for positioning the first device 110 to the first device 110. The configuration information comprises frequency hopping configuration associated with transmission of the first RS. Accordingly, the first device 110 receives the configuration information associated with the first RS from the second device 120.

Alternatively, the first device 110 may receive the configuration information associated with the first RS from the third device 130.

In some embodiments, the first RS may include but is not limited to a sounding reference signal (SRS). Hereinafter, embodiments of the present disclosure will be described by taking SRS for example. However, other types of reference signals may be applied to the embodiments of the present disclosure.

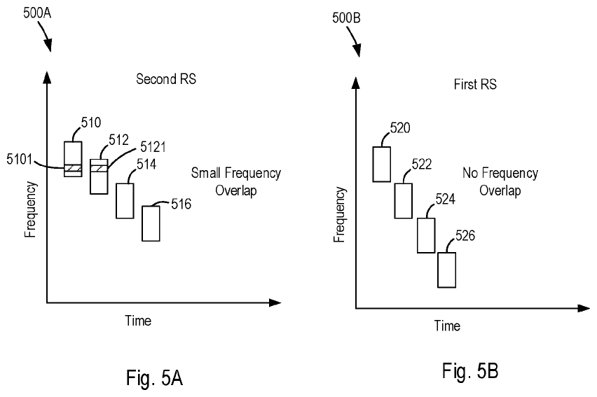

The second device 120 transmits 435 a second RS for positioning the first device 110 to the first device 110 on a first frequency hop and a second frequency hop overlapping with the first frequency hop in frequency domain. This will be described with reference to FIG. 5A.

FIG. 5A illustrates an example 500A of frequency hops for transmission of the second RS in accordance with some example embodiments of the present disclosure. As shown in FIG. 5A, the second device 120 transmits the second RS on frequency hops 510, 512, 514 and 516. There is an overlap in frequency domain between the frequency hops 510 and 512. There is an overlap in frequency domain between the frequency hops 512 and 514. There is an overlap in frequency domain between the frequency hops 514 and 516.

In some embodiments, the frequency hops 510, 512, 514 and 516 may be located on different BWPs from perspective of the first device 110. In such embodiments, the first device 110 may need to perform BWP switching to measure the second RS on the frequency hops 510, 512, 514 and 516.

In some embodiments, the second RS may include but is not limited to a positioning reference signal (PRS). Hereinafter, embodiments of the present disclosure will be described by taking PRS for example. However, other types of reference signals may be applied to the embodiments of the present disclosure.

With continued reference to FIG. 4, the first device 110 obtains 440 a phase offset from the received second RS.

In some embodiments, the first device 110 may obtain the phase offset from a first phase offset between a first part of the second RS on the first frequency hop and a second part of the second RS on the second frequency hop.

Consider the example 500A as shown in FIG. 5A. The first device 110 may receive the first part of the second RS on the frequency hop 510 and the second part of the second RS on the frequency hop 512. The first device 110 may obtain the first phase offset between the first part of the second RS on the frequency hop 510 and the second part of the second RS on the frequency hop 512. In turn, the first device 110 may obtain the phase offset for the pre-compensation from the first phase offset.

In some embodiments, the first phase offset may be between at least one first subcarrier on the first frequency hop and at least one second subcarrier on the second frequency hop. The at least one first and second subcarriers are within an overlap between the first frequency hop and the second frequency hop.

Still consider the example 500A as shown in FIG. 5A. A first subcarrier 5101 is on the frequency hop 510 and a second subcarrier 5121 is on the frequency hop 520. The first subcarrier 5101 and the second subcarrier 5121 are within an overlap between the frequency hop 510 and the frequency hop 512. For example, the first subcarrier 5101 and the second subcarrier 5121 may be located in the same position in frequency domain. In other words, the first subcarrier 5101 is the same as the second subcarrier 5121. The first phase offset may be between the first subcarrier 5101 and the second subcarrier 5121.

It will be understood that for the purpose of illustration, FIG. 5A shows only one subcarrier on each of the frequency hop 510 and the frequency hop 512 is within the overlap. In other embodiments, a plurality of subcarriers may be within the overlap. In such embodiments, the first device 110 may obtain a first plurality of phase offsets associated with the plurality of subcarriers. In turn, the first device 110 may determine one of the first plurality of phase offsets as the phase offset for the pre-compensation. Alternatively, the first device 110 may determine an average of the first plurality of phase offsets as the phase offset for the pre-compensation.

Returning to FIG. 4, the first device 110 causes 445 pre-compensation for the transmission of the first RS to be performed based on a phase offset obtained from the received second RS.

In turn, the first device 110 transmits 450 the first RS to the second device 120 based on the configuration information.

Upon receiving the first RS, the second device 120 may measure 455 the first RS. In embodiments where multi-RTT positioning of the first device 110 is performed, the second device 120 may measure the first RS to determine RTT between the second device 120 and the first device 110. In turn, the second device 120 may transmit the RTT to the third device 130 for positioning of the first device 110.

With the process 400, because pre-compensation for the transmission of the first RS is performed, the need for phase alignment at the second device 120 may be eliminated. Thus, complexity of the measurement procedure at the second device 120 may be reduced.

In some embodiments, the frequency hopping configuration in the configuration information associated with the first RS may indicate that there is no overlap in frequency domain between a third frequency hop and a fourth frequency hop for the transmission of the first RS. This will be described with reference to FIG. 5B.

FIG. 5B illustrates an example 500B of frequency hops for transmission of the first RS in accordance with some example embodiments of the present disclosure. As shown in FIG. 5B, the first device 110 transmits the first RS on frequency hops 520, 522, 524 and 526. There is no overlap in frequency domain between the frequency hops 520, 522, 524 and 526.

In some embodiments, the configuration information may further comprise resources associated with the first RS. For example, the configuration information may further comprise an indication that a first resource or a first BWP comprising the first frequency hop is used as a baseline for obtaining the phase offset. For another example, the configuration information may further comprise an indication that a second resource or a second BWP comprising the second frequency hop to which the phase offset is to be added.

Alternatively or additionally, in some embodiments, the configuration information may further comprise identifiers (IDs) of the resources associated with the first RS and resources associated with the second RS.

Alternatively or additionally, in some embodiments, the configuration information may further comprise identifiers of the first frequency hop, the second frequency hop, the third frequency hop and the fourth frequency hop.

In some embodiments, the second device 120 may transmit the configuration information by using at least one of the following: LTE Positioning Protocol (LPP), Radio Resource Control (RRC) signalling, or Medium Access Control Control Element (MAC CE).

In some embodiments, the first device 110 may perform the pre-compensation for the transmission of the first RS based on the phase offset.

Consider the example 500A in FIG. 5A and the example 500B in FIG. 5B. In these examples, in order to perform pre-compensation for transmission of a part of the first RS on the frequency hop 522 in FIG. 5B, the first device 110 may apply the first phase offset between the first part of the second RS on the frequency hop 510 and the second part of the second RS on the frequency hop 512.

In some embodiments, the first device 110 may transmit 410 capability information to the second device 120. The capability information may be indicative of a capability of the first device 100 to support performing the pre-compensation. In turn, upon receiving the capability information, the second device 120 may transmit 415 the capability information to the third device 130. Alternatively, the first device 110 may transmit the capability information to the third device 130 directly.

In some embodiments, the capability information may further indicate at least one of the following:
accuracy with which the first device 110 performs the pre-compensation,
maximum time between the third and fourth frequency hops that the first device 110 is allowed to perform the pre-compensation for, or
maximum number of frequency hops that the first device 110 performs the pre-compensation for.

Upon receiving the capability information, the third device 130 may transmit 420, to the first device 110, a first indication indicating the pre-compensation is to be performed by the first device 110. The third device 130 may also transmit 425, to the second device 120, the first indication indicating the pre-compensation is to be performed by the first device 110.

In embodiments where the first device 110 transmit the capability information to the second device 120, the second device 120 may transmit, to the first device 110, the first indication indicating the pre-compensation is to be performed by the first device 110.

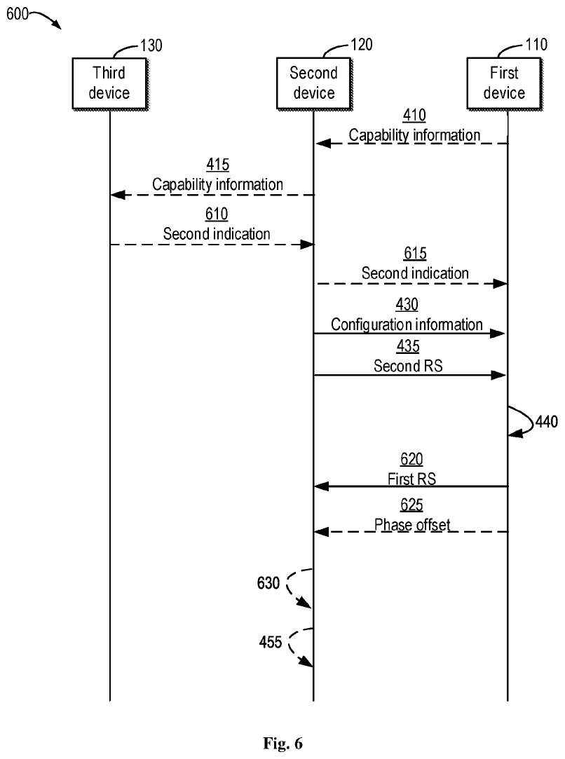

In some embodiments, the first device 110 may transmit the phase offset to the second device 120. Upon receiving the phase offset, the second device 120 may perform pre-compensation for the received first RS based on the phase offset. This will be described with reference to FIG. 6.

FIG. 6 illustrates a signaling chart illustrating a process 600 for positioning in accordance with some example embodiments of the present disclosure. For the purpose of discussion, the process 600 will be described with reference to FIG. 1. The process 600 may involve the first device 110, the second device 120 and the third device 130 in FIG. 1. The process 600 may considered as an example implementation of the process 400.

The actions 410, 415, 430, 435, 440 and 455 in the process 600 are the same as those in the process 400. Details of these actions are omitted for brevity.

The process 600 is different from the process 400 in actions 610, 615, 620, 625 and 630.

Specifically, the third device 130 transmits 610, to the second device 120, a second indication indicating the phase offset for the pre-compensation is to be transmitted by the first device 110. In turn, the second device 120 transmits 615 the second indication to the first device 110. Alternatively, the third device 130 may transmits the second indication to the first device 110 directly.

The first device 110 transmits 620 the first RS to the second device 120 based on the configuration information. The pre-compensation for the first RS is not performed by the first device 110.

In addition, the first device 110 transmits 625 the phase offset for the pre-compensation to the second device 120. Upon receiving the phase offset, the second device 120 performs 630 the pre-compensation for the received first RS based on the phase offset. Because the pre-compensation is performed by the second device 120, power of the first device may be saved.

In a second aspect, embodiments of the present disclosure provide a solution for positioning. In the solution, a second device receives a first RS for positioning a first device from the first device on a third frequency hop and a fourth frequency hop overlapping with the third frequency hop in frequency domain. The second device obtains a phase offset from the received first RS. In turn, the second device performs pre-compensation for the transmission of the second RS. In this way, the need for phase alignment at the receiver of the second RS may be eliminated.

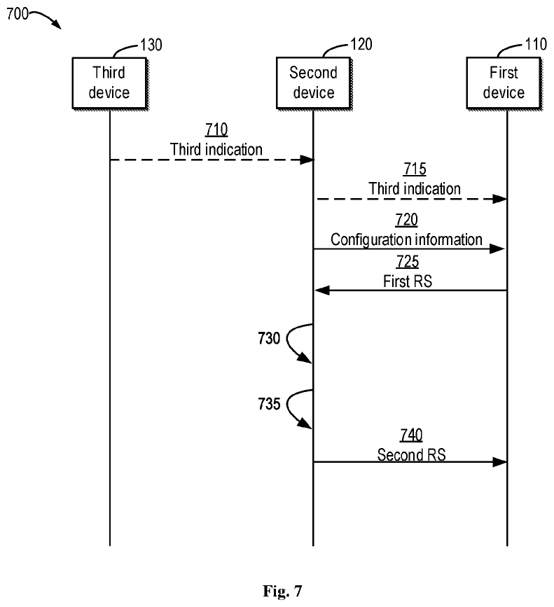

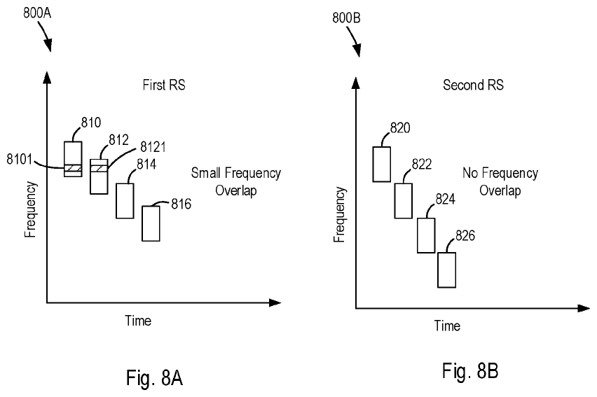

Hereinafter, some embodiments of the present disclosure according to the second aspect will be described with reference to FIGS. 7, 8a and 8b.

FIG. 7 illustrates a signaling chart illustrating a process 700 for positioning in accordance with some example embodiments of the present disclosure. For the purpose of discussion, the process 700 will be described with reference to FIG. 1. The process 700 may involve the first device 110, the second device 120 and the third device 130 in FIG. 1.

As shown in FIG. 7, the third device 130 transmits 710, to the second device 120, a third indication indicating the pre-compensation is to be performed by the second device 120. Upon receiving the third indication, the second device 120 transmits 715 the third indication to the first device 110. Alternatively, the third device 130 may transmit the third indication to the first device 110 directly.

The second device 120 transmits 720, to the first device 110, configuration information associated with a second RS for positioning the first device 110. The configuration information comprises frequency hopping configuration associated with transmission of the second RS. Accordingly, the first device 110 receives the configuration information associated with the second RS from the second device 120.

Alternatively, the first device 110 receives the configuration information associated with the second RS from the third device 130.

In some embodiments, the second RS may include but is not limited to a PRS. Hereinafter, embodiments of the present disclosure will be described by taking PRS for example. However, other types of reference signals may be applied to the embodiments of the present disclosure.

The second device 120 receives 725, from the first device 110, a first RS for positioning the first device 110 on a third frequency hop and a fourth frequency hop overlapping with the third frequency hop in frequency domain. This will be described with reference to FIG. 8A.

FIG. 8A illustrates an example 800A of frequency hops for transmission of the first RS in accordance with some example embodiments of the present disclosure. As shown in FIG. 8A, the second device 120 receives the first RS on frequency hops 810, 812, 814 and 816. There is an overlap in frequency domain between the frequency hops 810 and 812. There is an overlap in frequency domain between the frequency hops 812 and 814. There is an overlap in frequency domain between the frequency hops 814 and 816.

In some embodiments, the frequency hops 810, 812, 814 and 816 may be located on different BWP. In such embodiments, the second device 120 may need to perform BWP switching to measure the first RS on the frequency hops 810, 812, 814 and 816.

Because the first RS is transmitted on overlapping frequency hops, the first RS is stronger for phase alignment. Thus, more accurate positioning measurement may be performed.

In some embodiments, the first RS may include but is not limited to an SRS. Hereinafter, embodiments of the present disclosure will be described by taking SRS for example. However, other types of reference signals may be applied to the embodiments of the present disclosure.

With continued reference to FIG. 7, the second device 120 obtains 730 a phase offset from the received first RS.

In some embodiments, the second device 120 may obtain the phase offset from a second phase offset between a first part of the first RS on the third frequency hop and a second part of the first RS on the fourth frequency hop.

Consider the example 800A as shown in FIG. 8A. The second device 120 may receive the first part of the first RS on the frequency hop 810 and the second part of the first RS on the frequency hop 812. The second device 120 may obtain the second phase offset between the first part of the first RS on the frequency hop 810 and the second part of the first RS on the frequency hop 812. In turn, the second device 120 may obtain the phase offset for the pre-compensation from the second phase offset.

In some embodiments, the second phase offset may be between at least one third subcarrier on the third frequency hop and at least one fourth subcarrier on the fourth frequency hop. The at least one third and fourth subcarriers are within an overlap between the third frequency hop and the fourth frequency hop.

Still consider the example 800A as shown in FIG. 8A. A third subcarrier 8101 is on the frequency hop 810 and a fourth subcarrier 8121 is on the frequency hop 820. The third subcarrier 8101 and the fourth subcarrier 8121 are within an overlap between the frequency hop 810 and the frequency hop 812. For example, the third subcarrier 8101 and the fourth subcarrier 8121 may be located in the same position in frequency domain. The second phase offset may be between the third subcarrier 8101 and the fourth subcarrier 8121.

Returning to FIG. 7, the second device 120 performs 735 pre-compensation for transmission of the second RS based on a phase offset obtained from the received first RS.

In turn, the second device 120 transmits 740 the second RS to the first device 110 based on the configuration information.

With the process 700, because pre-compensation for the transmission of the second RS is performed, the need for phase alignment at the first device 110 may be eliminated. Thus, complexity of the measurement procedure at the first device 110 may be reduced.

In some embodiments, the frequency hopping configuration in the configuration information associated with the second RS may indicate that there is no overlap in frequency domain between a first frequency hop and a second frequency hop for the transmission of the second RS. This will be described with reference to FIG. 8B.

FIG. 8B illustrates an example 800B of frequency hops for transmission of the second RS in accordance with some example embodiments of the present disclosure. As shown in FIG. 8B, the second device 120 transmits the second RS on frequency hops 820, 822, 824 and 826. There is no overlap in frequency domain between the frequency hops 820, 822, 824 and 826.

Some embodiments of the process 400 may be applied to the process 700. Details of the embodiments are omitted for brevity.

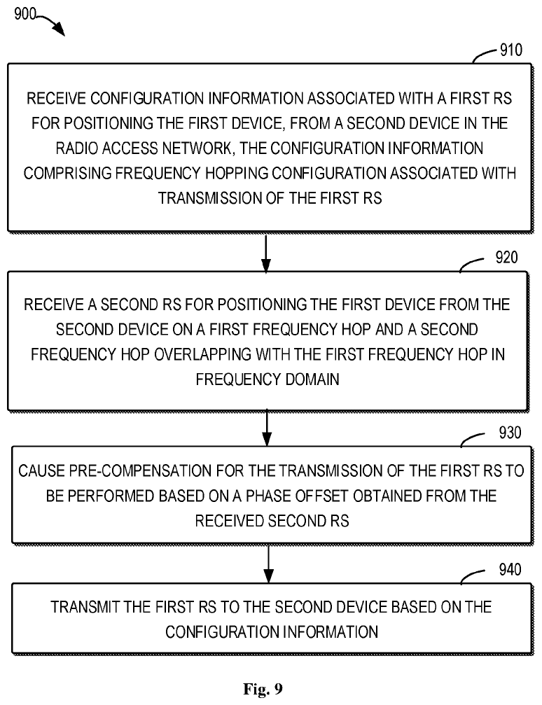

FIG. 9 shows a flowchart of an example method 900 implemented at a first device in accordance with some example embodiments of the present disclosure. For the purpose of discussion, the method 900 will be described from the perspective of the first device 110 with respect to FIG. 1.

At block 910, the first device 110 receives configuration information associated with a first RS for positioning the first device, from a second device in the radio access network. The configuration information comprises frequency hopping configuration associated with transmission of the first RS.

At block 920, the first device 110 receives a second RS for positioning the first device from the second device on a first frequency hop and a second frequency hop overlapping with the first frequency hop in frequency domain.

At block 930, the first device 110 causes pre-compensation for the transmission of the first RS to be performed based on a phase offset obtained from the received second RS.

At block 940, the first device 110 transmits the first RS to the second device based on the configuration information.

In some embodiments, the frequency hopping configuration indicates that there is no overlap in frequency domain between a third frequency hop and a fourth frequency hop for the transmission of the first RS.

In some embodiments, the phase offset is obtained from a first phase offset between a first part of the second RS on the first frequency hop and a second part of the second RS on the second frequency hop.

In some embodiments, the first phase offset is between at least one first subcarrier on the first frequency hop and at least one second subcarrier on the second frequency hop, the at least one first and second subcarriers are within an overlap between the first frequency hop and the second frequency hop.

In some embodiments, the at least one first subcarrier is the same as the at least one second subcarrier.

In some embodiments, causing the pre-compensation to be performed comprises performing the pre-compensation for the transmission of the first RS.

In some embodiments, the method 900 further comprises: transmitting capability information to the second device or a third device, the capability information indicative of a capability of the first device to support performing the pre-compensation; and receiving, from the second device or the third device, a first indication indicating the pre-compensation is to be performed by the first device.

In some embodiments, the capability information further indicates at least one of the following: accuracy with which the first device performs the pre-compensation, maximum time between the third and fourth frequency hops that the first device is allowed to perform the pre-compensation for, or maximum number of frequency hops that the first device performs the pre-compensation for.

In some embodiments, configuration information further comprises at least one of the following: resources associated with the first RS, identifiers of the resources associated with the first RS and resources associated with the second RS, or identifiers of the first frequency hop, the second frequency hop, the third frequency hop and the fourth frequency hop.

In some embodiments, causing the pre-compensation to be performed comprises transmitting the phase offset to the second device.

In some embodiments, the first RS comprises sounding reference signal, and the second RS comprises positioning reference signal.

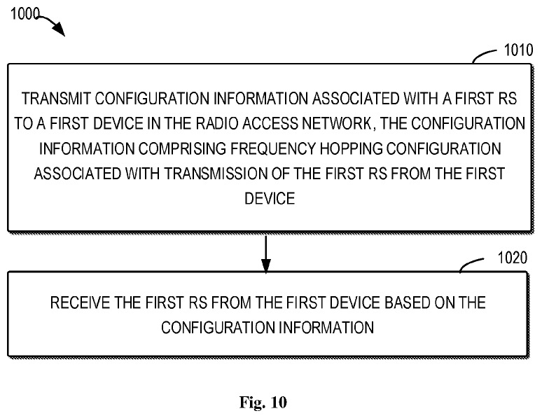

FIG. 10 shows a flowchart of an example method 1000 implemented at a second device in accordance with some example embodiments of the present disclosure. For the purpose of discussion, the method 1000 will be described from the perspective of the second device 120 with respect to FIG. 1.

At block 1010, the second device 120 transmits configuration information associated with a first RS to a first device in the radio access network. The configuration information comprises frequency hopping configuration associated with transmission of the first RS from the first device.

At block 1020, the second device 120 receives the first RS from the first device based on the configuration information.

In some embodiments, the frequency hopping configuration indicates that there is no overlap in frequency domain between a third frequency hop and a fourth frequency hop for the transmission of the first RS.

In some embodiments, the method 1000 further comprises: transmitting, to the first device, a second RS for positioning the first device on a first frequency hop and a second frequency hop overlapping with the first frequency hop in frequency domain; receiving a phase offset from the first device, In some embodiments, the phase offset is obtained from a first phase offset between a first part of the second RS on the first frequency hop and a second part of the second RS on the second frequency hop; and performing pre-compensation for the received first RS based on the phase offset.

In some embodiments, the first phase offset is between at least one first subcarrier on the first frequency hop and at least one second subcarrier on the second frequency hop, the at least one first and second subcarriers are within an overlap between the first frequency hop and the second frequency hop.

In some embodiments, the method 1000 further comprises: receiving capability information from the first device, the capability information indicative of a capability of the first device to support performing the pre-compensation; and transmitting, to the first device, a first indication indicating the pre-compensation is to be performed by the first device.

In some embodiments, the capability information further indicates at least one of the following: accuracy with which the first device performs the pre-compensation, maximum time between the third and fourth frequency hops that the first device is allowed to perform the pre-compensation for, or maximum number of frequency hops that the first device performs the pre-compensation for.

In some embodiments, configuration information further comprises at least one of the following: resources associated with the first RS, identifiers of the resources associated with the first RS and resources associated with the second RS, or identifiers of the first frequency hop, the second frequency hop, the third frequency hop and the fourth frequency hop.

In some embodiments, the first RS comprises sounding reference signal, and the second RS comprises positioning reference signal.

FIG. 11 shows a flowchart of an example method 1100 implemented at a third device in accordance with some example embodiments of the present disclosure. For the purpose of discussion, the method 1100 will be described from the perspective of the third device 130 with respect to FIG. 1.

At block 1110, the third device 130 transmits, to at least one of a first device and a second device in a radio access network, an indication indicating pre-compensation is to be performed. The pre-compensation is for transmission of an RS for positioning of the first device.

In some embodiments, the method 1100 further comprises: receiving capability information from the first device, the capability information indicative of a capability of the first device to support performing the pre-compensation.

In some embodiments, the pre-compensation is performed by the first device or the second device.

In some embodiments, the RS comprises at least one of sounding reference signal or positioning reference signal.

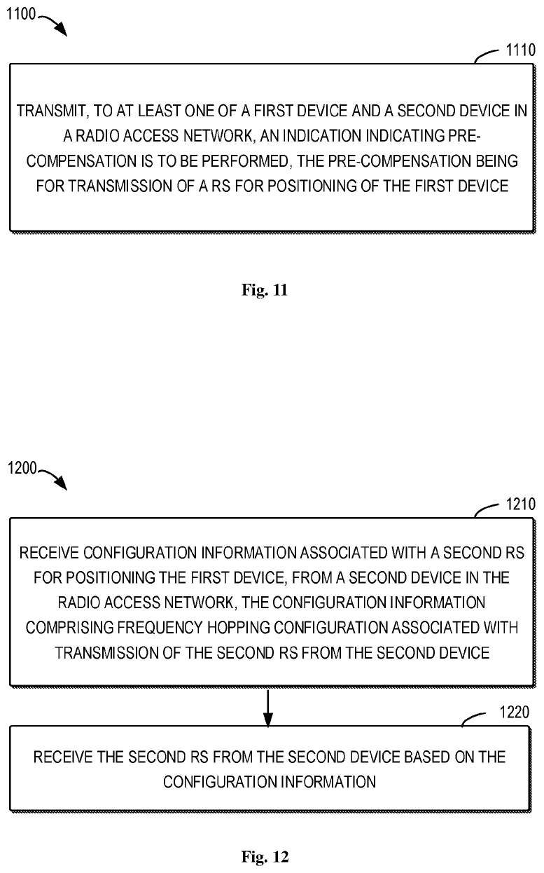

FIG. 12 shows a flowchart of an example method 1200 implemented at a first device in accordance with some example embodiments of the present disclosure. For the purpose of discussion, the method 1200 will be described from the perspective of the first device 110 with respect to FIG. 1.

At block 1210, the first device 110 receives configuration information associated with a second RS for positioning the first device, from a second device in the radio access network. The configuration information comprises frequency hopping configuration associated with transmission of the second RS from the second device.

At block 1220, the first device 110 receives the second RS from the second device based on the configuration information.

In some embodiments, the frequency hopping configuration indicates that there is no overlap in frequency domain between a first frequency hop and a second frequency hop for the transmission of the second RS.

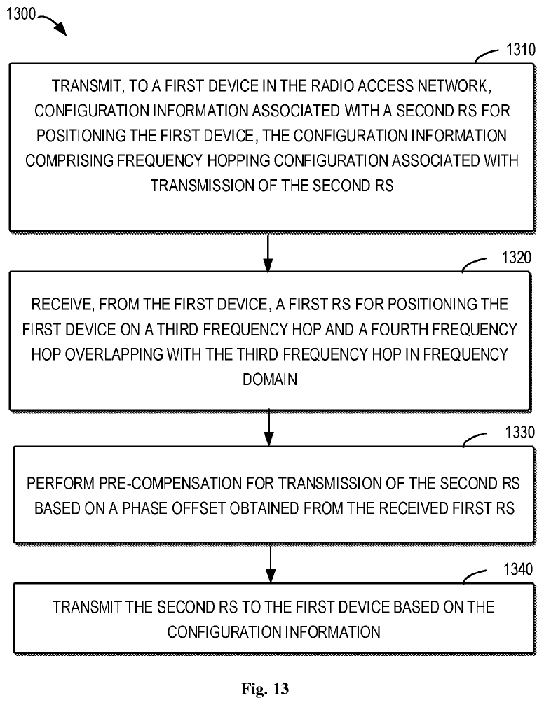

FIG. 13 shows a flowchart of an example method 1300 implemented at a second device in accordance with some example embodiments of the present disclosure. For the purpose of discussion, the method 1300 will be described from the perspective of the second device 120 with respect to FIG. 1.

At block 1310, the second device 120 transmits, to a first device in the radio access network, configuration information associated with a second RS for positioning the first device. The configuration information comprises frequency hopping configuration associated with transmission of the second RS.

At block 1320, the second device 120 receives, from the first device, a first RS for positioning the first device on a third frequency hop and a fourth frequency hop overlapping with the third frequency hop in frequency domain.

At block 1330, the second device 120 performs pre-compensation for transmission of the second RS based on a phase offset obtained from the received first RS.

At block 1340, the second device 120 transmits the second RS to the first device based on the configuration information.

In some embodiments, the frequency hopping configuration indicates that there is no overlap in frequency domain between a first frequency hop and a second frequency hop for the transmission of the second RS.

In some embodiments, the phase offset is obtained from a second phase offset between a first part of the first RS on the third frequency hop and a second part of the first RS on the fourth frequency hop.

In some embodiments, the second phase offset is between at least one third subcarrier on the third frequency hop and at least one fourth subcarrier on the fourth frequency hop, the at least one third and fourth subcarriers are within an overlap between the third frequency hop and the fourth frequency hop.

In some embodiments, the at least one third subcarrier is the same as the at least one fourth subcarrier.

In some example embodiments, a first apparatus in a radio access network capable of performing any of the method 900 (for example, the first device 110) may comprise means for performing the respective operations of the method 900. The means may be implemented in any suitable form. For example, the means may be implemented in a circuitry or software module. The first apparatus may be implemented as or included in the first device 110. In some example embodiments, the means may comprise a processor and a memory.

In some example embodiments, the first apparatus comprises: means for receiving configuration information associated with a first RS for positioning the first device, from a second device in the radio access network, the configuration information comprising frequency hopping configuration associated with transmission of the first RS; means for receiving a second RS for positioning the first device from the second device on a first frequency hop and a second frequency hop overlapping with the first frequency hop in frequency domain; means for causing pre-compensation for the transmission of the first RS to be performed based on a phase offset obtained from the received second RS; and means for transmitting the first RS to the second device based on the configuration information.

In some embodiments, the frequency hopping configuration indicates that there is no overlap in frequency domain between a third frequency hop and a fourth frequency hop for the transmission of the first RS.

In some embodiments, the phase offset is obtained from a first phase offset between a first part of the second RS on the first frequency hop and a second part of the second RS on the second frequency hop.

In some embodiments, the first phase offset is between at least one first subcarrier on the first frequency hop and at least one second subcarrier on the second frequency hop, the at least one first and second subcarriers are within an overlap between the first frequency hop and the second frequency hop.

In some embodiments, the at least one first subcarrier is the same as the at least one second subcarrier.

In some embodiments, the means for causing the pre-compensation to be performed comprises means for performing the pre-compensation for the transmission of the first RS.

In some embodiments, the apparatus further comprises: means for transmitting capability information to the second device or a third device, the capability information indicative of a capability of the first device to support performing the pre-compensation; and means for receiving, from the second device or the third device, a first indication indicating the pre-compensation is to be performed by the first device.

In some embodiments, the capability information further indicates at least one of the following: accuracy with which the first device performs the pre-compensation, maximum time between the third and fourth frequency hops that the first device is allowed to perform the pre-compensation for, or maximum number of frequency hops that the first device performs the pre-compensation for.

In some embodiments, configuration information further comprises at least one of the following: resources associated with the first RS, identifiers of the resources associated with the first RS and resources associated with the second RS, or identifiers of the first frequency hop, the second frequency hop, the third frequency hop and the fourth frequency hop.

In some embodiments, the means for causing the pre-compensation to be performed comprises means for transmitting the phase offset to the second device.

In some embodiments, the first RS comprises sounding reference signal, and the second RS comprises positioning reference signal.

In some example embodiments, a second apparatus in a radio access network capable of performing any of the method 1000 (for example, the second device 120) may comprise means for performing the respective operations of the method 1000. The means may be implemented in any suitable form. For example, the means may be implemented in a circuitry or software module. The second apparatus may be implemented as or included in the second device 120. In some example embodiments, the means may comprise a processor and a memory.

In some example embodiments, the second apparatus comprises: means for transmitting configuration information associated with a first RS to a first device in the radio access network, the configuration information comprising frequency hopping configuration associated with transmission of the first RS from the first device; and means for receiving the first RS from the first device based on the configuration information.

In some embodiments, the frequency hopping configuration indicates that there is no overlap in frequency domain between a third frequency hop and a fourth frequency hop for the transmission of the first RS.

In some embodiments, the second apparatus further comprises: means for transmitting, to the first device, a second RS for positioning the first device on a first frequency hop and a second frequency hop overlapping with the first frequency hop in frequency domain; means for receiving a phase offset from the first device, In some embodiments, the phase offset is obtained from a first phase offset between a first part of the second RS on the first frequency hop and a second part of the second RS on the second frequency hop; and means for performing pre-compensation for the received first RS based on the phase offset.

In some embodiments, the first phase offset is between at least one first subcarrier on the first frequency hop and at least one second subcarrier on the second frequency hop, the at least one first and second subcarriers are within an overlap between the first frequency hop and the second frequency hop.

In some embodiments, the second apparatus further comprises: means for receiving capability information from the first device, the capability information indicative of a capability of the first device to support performing the pre-compensation; and means for transmitting, to the first device, a first indication indicating the pre-compensation is to be performed by the first device.

In some embodiments, the capability information further indicates at least one of the following: accuracy with which the first device performs the pre-compensation, maximum time between the third and fourth frequency hops that the first device is allowed to perform the pre-compensation for, or maximum number of frequency hops that the first device performs the pre-compensation for.

In some embodiments, configuration information further comprises at least one of the following: resources associated with the first RS, identifiers of the resources associated with the first RS and resources associated with the second RS, or identifiers of the first frequency hop, the second frequency hop, the third frequency hop and the fourth frequency hop.

In some embodiments, the first RS comprises sounding reference signal, and the second RS comprises positioning reference signal.

In some example embodiments, a third apparatus in a core network or in a radio access network capable of performing any of the method 1100 (for example, the third device 130) may comprise means for performing the respective operations of the method 1100. The means may be implemented in any suitable form. For example, the means may be implemented in a circuitry or software module. The third apparatus may be implemented as or included in the third device 130. In some example embodiments, the means may comprise a processor and a memory.

In some example embodiments, the third apparatus comprises means for transmitting, to at least one of a first device and a second device in a radio access network, an indication indicating pre-compensation is to be performed, the pre-compensation being for transmission of an RS for positioning of the first device.

In some embodiments, the method 1100 further comprises: receiving capability information from the first device, the capability information indicative of a capability of the first device to support performing the pre-compensation.

In some embodiments, the pre-compensation is performed by the first device or the second device.

In some embodiments, the RS comprises at least one of sounding reference signal or positioning reference signal.

In some example embodiments, a first apparatus in a radio access network capable of performing any of the method 1200 (for example, the first device 110) may comprise means for performing the respective operations of the method 1200. The means may be implemented in any suitable form. For example, the means may be implemented in a circuitry or software module. The first apparatus may be implemented as or included in the first device 110. In some example embodiments, the means may comprise a processor and a memory.

In some example embodiments, the first apparatus comprises: means for receiving configuration information associated with a second RS for positioning the first device, from a second device in the radio access network, the configuration information comprising frequency hopping configuration associated with transmission of the second RS from the second device; and means for receiving the second RS from the second device based on the configuration information.

In some embodiments, the frequency hopping configuration indicates that there is no overlap in frequency domain between a first frequency hop and a second frequency hop for the transmission of the second RS.

In some example embodiments, a second apparatus in a radio access network capable of performing any of the method 1300 (for example, the second device 120) may comprise means for performing the respective operations of the method 1300. The means may be implemented in any suitable form. For example, the means may be implemented in a circuitry or software module. The second apparatus may be implemented as or included in the second device 120. In some example embodiments, the means may comprise a processor and a memory.

In some example embodiments, the second apparatus comprises: means for transmitting, to a first device in the radio access network, configuration information associated with a second RS for positioning the first device, the configuration information comprising frequency hopping configuration associated with transmission of the second RS; means for receiving, from the first device, a first RS for positioning the first device on a third frequency hop and a fourth frequency hop overlapping with the third frequency hop in frequency domain; means for performing pre-compensation for transmission of the second RS based on a phase offset obtained from the received first RS; and means for transmitting the second RS to the first device based on the configuration information.

In some embodiments, the frequency hopping configuration indicates that there is no overlap in frequency domain between a first frequency hop and a second frequency hop for the transmission of the second RS.

In some embodiments, the phase offset is obtained from a second phase offset between a first part of the first RS on the third frequency hop and a second part of the first RS on the fourth frequency hop.

In some embodiments, the second phase offset is between at least one third subcarrier on the third frequency hop and at least one fourth subcarrier on the fourth frequency hop, the at least one third and fourth subcarriers are within an overlap between the third frequency hop and the fourth frequency hop.

In some embodiments, the at least one third subcarrier is the same as the at least one fourth subcarrier.

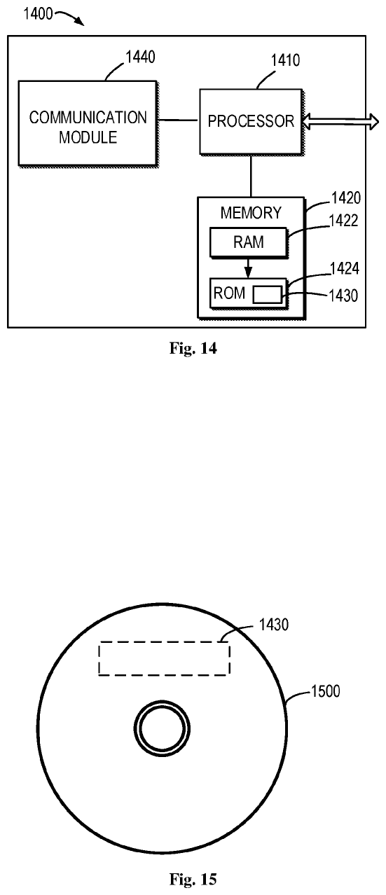

FIG. 14 is a simplified block diagram of a device 1400 that is suitable for implementing example embodiments of the present disclosure. The device 1400 may be provided to implement a communication device, for example, the first device 110, the second device 120, or the third device 130 as shown in FIG. 1. As shown, the device 1400 includes one or more processors 1410, one or more memories 1420 coupled to the processor 1410, and one or more communication modules 1440 coupled to the processor 1410.

The communication module 1440 is for bidirectional communications. The communication module 1440 has one or more communication interfaces to facilitate communication with one or more other modules or devices. The communication interfaces may represent any interface that is necessary for communication with other network elements. In some example embodiments, the communication module 1440 may include at least one antenna.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1422 and other volatile memories that will not last in the power-down duration.

A computer program 1430 includes computer executable instructions that could be executed by the associated processor 1410. The program 1430 may be stored in the memory, e.g., ROM 1424. The processor 1410 may perform any suitable actions and processing by loading the program 1430 into the RAM 1422.

The example embodiments of the present disclosure may be implemented by means of the program 1430 so that the device 1400 may perform any process of the disclosure as discussed with reference to FIGS. 1 to 13. The example embodiments of the present disclosure may also be implemented by hardware or by a combination of software and hardware.

In some example embodiments, the program 1430 may be tangibly contained in a computer readable medium which may be included in the device 1400 (such as in the memory 1420) or other storage devices that are accessible by the device 1400. The device 1400 may load the program 1430 from the computer readable medium to the RAM 1422 for execution. The computer readable medium may include any types of tangible non-volatile storage, such as ROM, EPROM, a flash memory, a hard disk, CD, DVD, and the like. FIG. 15 shows an example of the computer readable medium 1500 which may be in form of CD, DVD or other optical storage disk. The computer readable medium has the program 1430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 1 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be appreciated that though some embodiments may be implemented by/at IAB nodes, solutions including methods and apparatus proposed in this disclosure could also be applied in other communication systems where similar technical problems exist. Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device in a radio access network, comprising:
at least one processor; and
at least one memory storing instructions that, when executed by the at least one processor, cause the first device at least to:
receive configuration information associated with a first reference signal, RS, for positioning the first device, from a second device in the radio access network, the configuration information comprising frequency hopping configuration associated with transmission of the first RS;
receive a second RS for positioning the first device from the second device on a first frequency hop and a second frequency hop overlapping with the first frequency hop in frequency domain;
cause pre-compensation for the transmission of the first RS to be performed based on a phase offset obtained from the received second RS; and
transmit the first RS to the second device based on the configuration information.

2. The first device of claim 1, wherein the frequency hopping configuration indicates that there is no overlap in frequency domain between a third frequency hop and a fourth frequency hop for the transmission of the first RS.

3. The first device of claim 1, wherein the phase offset is obtained from a first phase offset between a first part of the second RS on the first frequency hop and a second part of the second RS on the second frequency hop.

4. The first device of claim 3, wherein the first phase offset is between at least one first subcarrier on the first frequency hop and at least one second subcarrier on the second frequency hop, the at least one first and second subcarriers are within an overlap between the first frequency hop and the second frequency hop.

5. The first device of claim 4, wherein the at least one first subcarrier is the same as the at least one second subcarrier.

6. The first device of claim 1, wherein the first device is caused to perform the pre-compensation for the transmission of the first RS.

7. The first device of claim 6, wherein the first device is further caused to:
transmit capability information to the second device or a third device, the capability information indicative of a capability of the first device to support performing the pre-compensation; and
receive, from the second device or the third device, a first indication indicating the pre-compensation is to be performed by the first device.

8. The first device of claim 7, wherein the capability information further indicates at least one of the following:
accuracy with which the first device performs the pre-compensation,
maximum time between the third and fourth frequency hops that the first device is allowed to perform the pre-compensation for, or
maximum number of frequency hops that the first device performs the pre-compensation for.

9. The first device of claim 2, wherein configuration information further comprises at least one of the following:
resources associated with the first RS,
identifiers of the resources associated with the first RS and resources associated with the second RS, or
identifiers of the first frequency hop, the second frequency hop, the third frequency hop and the fourth frequency hop.

10. The first device of claim 1, wherein the first device is caused to perform the pre-compensation for the transmission of the first RS by:
transmitting the phase offset to the second device.

11. The first device of claim 1, wherein the first RS comprises sounding reference signal, and the second RS comprises positioning reference signal.

12. A second device in a radio access network, comprising:
at least one processor; and
at least one memory storing instructions that, when executed by the at least one processor, cause the second device at least to:
transmit configuration information associated with a first reference signal, RS, to a first device in the radio access network, the configuration information comprising frequency hopping configuration associated with transmission of the first RS from the first device; and
receive the first RS from the first device based on the configuration information.

13. The second device of claim 12, wherein the frequency hopping configuration indicates that there is no overlap in frequency domain between a third frequency hop and a fourth frequency hop for the transmission of the first RS.

14. The second device of claim 12, wherein the second device is further caused to:
transmit, to the first device, a second RS for positioning the first device on a first frequency hop and a second frequency hop overlapping with the first frequency hop in frequency domain;
receive a phase offset from the first device, wherein the phase offset is obtained from a first phase offset between a first part of the second RS on the first frequency hop and a second part of the second RS on the second frequency hop; and
perform pre-compensation for the received first RS based on the phase offset.

15. The second device of claim 14, wherein the first phase offset is between at least one first subcarrier on the first frequency hop and at least one second subcarrier on the second frequency hop, the at least one first and second subcarriers are within an overlap between the first frequency hop and the second frequency hop.

16. The second device of claim 15, wherein the at least one first subcarrier is the same as the at least one second subcarrier.

17. The second device of claim 12, wherein the second device is further caused to:
receive capability information from the first device, the capability information indicative of a capability of the first device to support performing the pre-compensation; and
transmit, to the first device, a first indication indicating the pre-compensation is to be performed by the first device.

18. The second device of claim 17, wherein the capability information further indicates at least one of the following:
accuracy with which the first device performs the pre-compensation,
maximum time between the third and fourth frequency hops that the first device is allowed to perform the pre-compensation for, or
maximum number of frequency hops that the first device performs the pre-compensation for.

19. The second device of claim 14, wherein configuration information further comprises at least one of the following:
resources associated with the first RS,
identifiers of the resources associated with the first RS and resources associated with the second RS, or
identifiers of the first frequency hop, the second frequency hop, the third frequency hop and the fourth frequency hop.

20. The second device of claim 12, wherein the first RS comprises sounding reference signal, and the second RS comprises positioning reference signal.

21. A third device, comprising:
at least one processor; and
at least one memory storing instructions that, when executed by the at least one processor, cause the third device at least to:
transmit, to at least one of a first device and a second device in a radio access network, an indication indicating pre-compensation is to be performed, the pre-compensation being for transmission of a reference signal, RS, for positioning of the first device.

22. The third device of claim 21, wherein the third device is further caused to:
receive capability information from the first device, the capability information indicative of a capability of the first device to support performing the pre-compensation.

23-42. (canceled)
